(19) United States
(12) Patent Application Publication
(10) Pub. No.: US 2007/0250859 A1
(43) Pub. Date: Oct. 25, 2007

(54) Network content display device

(75) Inventors: Hideki Ohkita, Kunitachi-shi (JP); Shigeru Maeda, Tachikawa-shi (JP); Kazunobu Konda, Tokyo (JP); Ken Matsushita, Tama-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/730,052

(22) Filed: Mar. 29, 2007

(30) Foreign Application Priority Data
Mar. 31, 2006 (JP) 2006-101116

(51) Int. Cl. H04N 5/445; G06F 17/00; G06F 15/00; H04N 7/173; G06F 3/00; G06F 13/00; G04G 11/00

(52) U.S. Cl. 725/44; 708/112; 725/39; 725/88; 725/89; 725/45

(57) ABSTRACT

An information acquiring unit acquires information relating to image contents possessed by a plurality of communication devices connected to a network, via a communication unit. A display management unit displays a calendar screen including a plurality of display areas configured in days onto a display unit, and displays information about each image content acquired by the information acquiring unit onto the calendar screen on the basis of recording dates and times of the image contents.

### CROSS-REFERENCE TO RELATED APPLICATIONS

This application is based upon and claims the benefit of priority from Japanese Patent Application No. 2006-101116, filed Mar. 31, 2006, the entire contents of which are incorporated herein by reference.

### BACKGROUND

1. Field

The present invention relates to a network content display device which displays image contents possessed by a communication device connected via a network.

2. Description of the Related Art

A record reproduction device which displays a list of recoded image contents by using a calendar screen is disclosed by Jpn. Pat. Appln. KOKAI Publication No. 2004-297649. In this document, the reproduction device records the image contents of which the recording dates are important in an HDD, and selects to reproduce the content by means of the calendar screen in reproduction.

The document does not suppose at all to display list of image contents recorded in a plurality of communication devices connected to a communication network. Further, the document includes the problem that a motion image icon or a still image icon is displayed at the date when any content is present on the calendar, and even if a plurality of contents belonging to the same date are displayed with one icon, so that the detail of the content cannot be grasped.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting a configuration example of a system to which the invention is applied;

FIG. 2 is an exemplary view depicting an example of a metadata list;

FIG. 3 is an exemplary block diagram depicting an embodiment of a network content display device 10 in the invention;

FIG. 4 is an exemplary view depicting a relationship between metadata stored in a metadata management unit 17 and items displayed on a retrieval result screen;

FIG. 5 is an exemplary view depicting a first embodiment of a content list display screed by the network content display device 10 of the invention;

FIG. 6 is an exemplary view depicting a second embodiment of the content list display screen by the network content display device 10 of the invention;

FIG. 7 is an exemplary view depicting a third embodiment of the content list display screen by the network content display device 10 of the invention;

FIG. 8 is an exemplary view depicting a fourth embodiment of the content list display screen by the network content display device 10 of the invention;

FIG. 9 is an exemplary view depicting a fifth embodiment of the content list display screen by the network content display device 10 of the invention;

FIG. 10 is an exemplary view depicting a sixth embodiment of the content list display screen by the network content display device 10 of the invention;

FIG. 11 is an exemplary flowchart depicting a basic operation of the network content display device 10 of the invention;

FIG. 12 is an exemplary flowchart to create a display screen in FIG. 5;

FIG. 13 is an exemplary flowchart to create a display screen in FIG. 6;

FIG. 14 is an exemplary flowchart to create a display screen in FIG. 7;

FIG. 15 is an exemplary flowchart to create a display screen in FIG. 8;

FIG. 16 is an exemplary flowchart to create a display screen in FIG. 9; and

FIG. 17 is an exemplary flowchart to create a display screen in FIG. 10.

### DETAILED DESCRIPTION

Various embodiments according to the invention will be described hereinafter with reference to the accompanying drawings. In general, according to one embodiment of the invention, there is provided, a network content display device, comprising: a communication unit which communicates with a plurality of communication devices each having image contents, via a network; an information acquiring unit which acquires information relating to image contents possessed by the plurality of communication devices connected to the network; and a display management unit which displays a calendar screen including a plurality of display areas configured in days and displays information relating each image content acquired by the information acquiring unit on the calendar screen on the basis of recording dates and times of the image contents.

According to one embodiment of the invention, a list showing the details of the image contents recorded in the plurality of video recording/reproducing appliances connected to a communication network can be easily displayed by using the calendar screen.

Embodiments Of the invention will be described by referring to the drawings hereinafter.

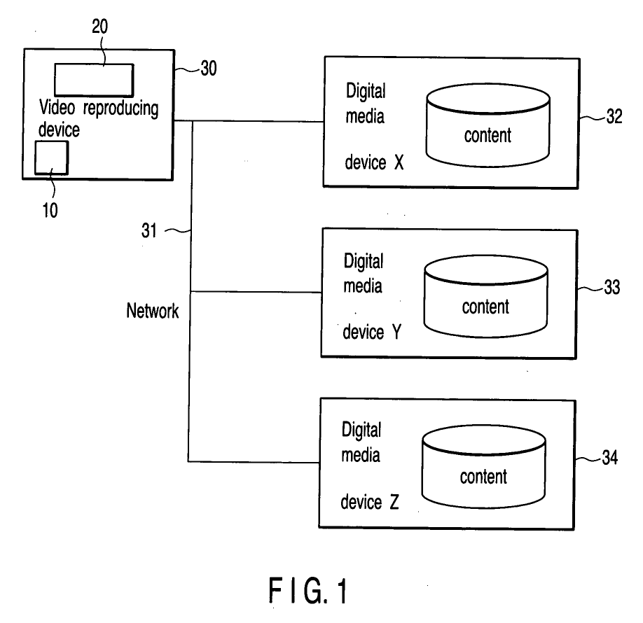

FIG. 1 is a view illustrating a configuration example of a system to which the invention is applied. A video reproducing device 30 having a network content display device 10 that is an embodiment of the invention is connected to a plurality of digital media devices (hereinafter referred to devices) 32-34 via a communication network 31.

The reproducing device 30 is, for instance, a digital television receiver to receive and reproduce a digital broadcasting, and each device 32-34 is, for example, a video recording/reproducing device, or a video reproducing device, such as a DVD recorder, a personal computer, or a digital camera. Each device 32-34 can communicate with the reproducing device 30 via the network 31. The network 31 is, for instance, a home network installed at a usual home.

The display device 10 provided in the reproducing device 30 accesses the devices 32-34 via the network 31 to acquire metadata accompanying the image contents stored in each device 32-34, and creates a list of the metadata. Here, the metadata includes, for example, outline information of content to identify and sort each content, such as a title, a recording date and time.

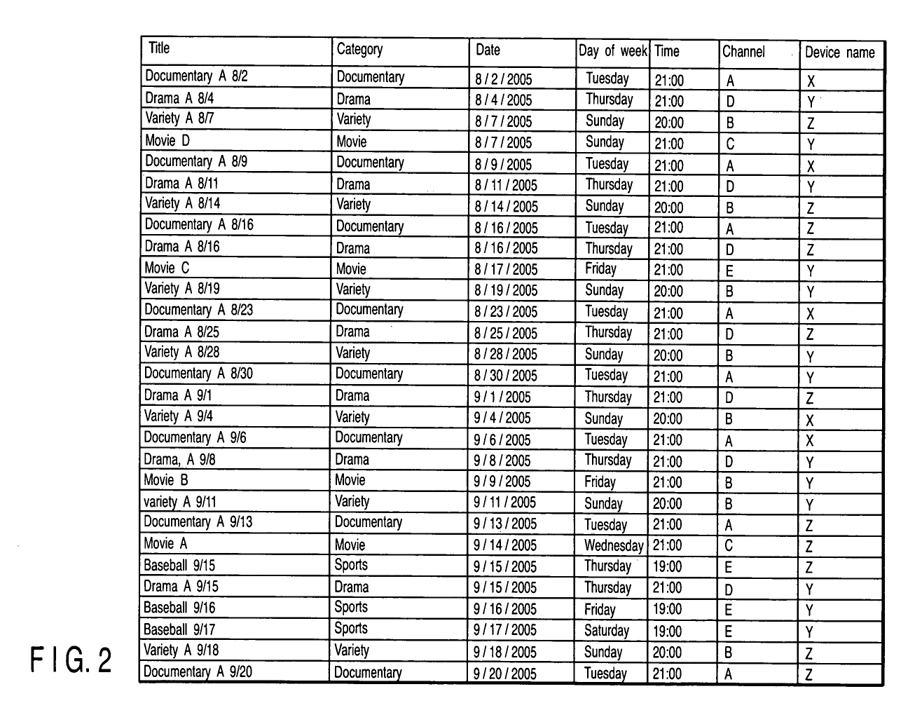

FIG. 2 shows an example of a metadata list. The metadata includes information, such as titles, categories, recording days and times, days of the week, recording start times, channels, and device names of the contents. Here, an example is shown, in which a metadata management unit 17 manages the metadata of the three devices X, Y and Z as one table.

Like this manner, the display device 10 can comprehensively treat contents regardless of their whereabouts (devices) by managing the metadata of the contents owned in a plurality of devices in the one table. A user, as mentioned later, becomes possible to operate contents through the display device 10 without being aware of the whereabouts of the content. The types of contents include a still image and a motion image photographed by a digital camera or a video camera other than video programs shown in FIG. 2.

The display device 10 creates a content list on the basis of the table of the metadata. The reproducing device 30 displays the content list created by the display device 10 onto a display unit 20. The reproducing device 30 acquires and reproduces the image data of the content which has been selected by the user depending on the content list via the network 31 and displays it onto the display unit 20.

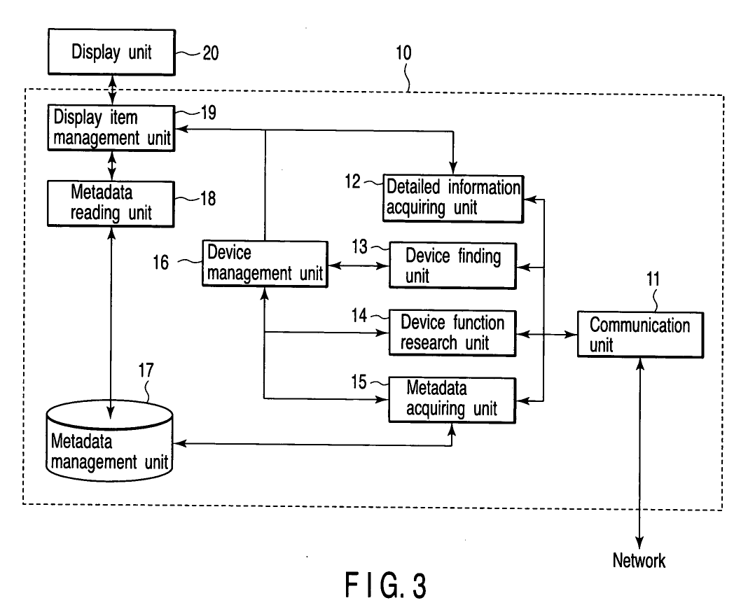

FIG. 3 is a block diagram illustrating a configuration of the display device 10 in the embodiment.

A device finding unit 13 finds a device with power supplied thereto on the network 31 through a communication unit 11 to report it to a device management unit 16. When the content stored in each device is updated, the device finding unit 13 detects the fact to notify it to the device management unit 16.

Device management unit 16 instructs a device function research unit 14 to research the function of the found device through the communication unit 11. Here, a retrieval function for contents is presumed as a function of the device. The function is a function to support a retrieval command, such as “Browse” and “Search” described in a universal plug and play (UPnP) specification concretely.

The device management unit 16 acquires the metadata of the contents stored in the devices through a metadata acquiring unit 15 on the basis of the research result from the research unit 14 to store it in a metadata management unit 17. After completing the acquisition of the metadata, the device management unit 16 notifies the completion of the metadata acquisition to a display item management unit 19.

The item management unit 19 acquires the metadata required to display through a metadata reading unit 18. At this moment, if the information necessary for displaying is in shortage, the item management unit 19 acquires detailed information from the devices through a detailed information acquiring unit 12. The item management unit 19 displays the metadata and detailed information onto the display unit 20.

The metadata is the information also needed for a retrieval and sort of the display items and for detailed information display positions of the contents in the content list. The item management unit 19 determining a display order and positions of the contents from the metadata, when acquiring the metadata, the metadata acquiring unit 15 of the display device 10 has to acquire metadata of all contents from each device.

On the other hand, the detailed information is information needed for the item management unit 19 to actually layout and display the content list onto the screen of the display unit 20, etc. The detailed information acquiring unit 12 may acquire only the detailed information relating to the contents to be actually displayed on the display from among the detailed information regarding all metadata stored in the metadata management unit 17.

One example of the detailed information treated by the detailed information acquiring unit 12 includes thumbnails (reduced images) and information about content descriptions, performers, etc., of the contents acquired from an electronic program guide (EPG) of the content. The metadata and the detailed information shown in the embodiment is each one example, and depending on a specification of an application, for example, there are some cases in which the program descriptions are treated as the metadata, or inversely, the information about date and time, etc., is treated as the detailed information. In the embodiment mentioned below, the thumbnails are treated as the detailed information.

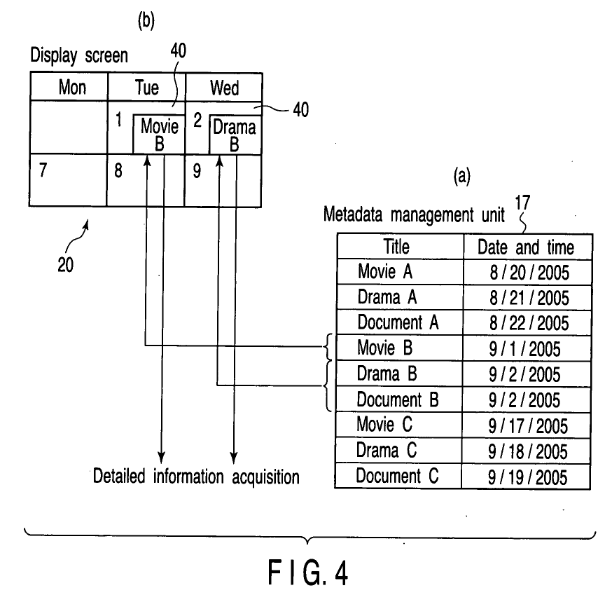

FIG. 4 is a view illustrating a relationship between the metadata stored in the metadata management unit 17 and the items indicated on the retrieval result screen (content list). The content list being possible to be displayed in a various types of forms, a mere date order as shown, date orders for each device, it is supposed that in the following embodiment, a display in a calendar form is selected by the user.

The metadata management unit 17, as shown (a) of FIG. 4, stores the metadata, such as titles of contents and recording dates and times of the recorded content, as the retrieval result.

When displaying the retrieval result onto the display unit 20 in a calendar form shown at (b) of FIG. 4, the item management unit 19 firstly acquires the metadata corresponding to each date cell (rectangular display area) 40 from the metadata management unit 17. Here, the item management unit 19 obtains the metadata (date and title) of a movie B on September first, a drama B and a documentary B on September second. After this, the item management unit 19 acquires the detailed information (thumbnail in the embodiment) from the devices on the network 31 through the detailed information acquiring unit 12.

In the case of FIG. 4, the display item management unit 19 acquires thumbnail information from the corresponding device so as to conduct a thumbnail display on the calendar screen for the movie B and drama B. Like this way, the metadata management unit 17 stores the metadata, such as title and date, necessary for selecting or sorting the content, such as titles and dates of all contents of all powered on devices. In contrast, in regard to the information with large volume which is needed only in displaying thumbnail, etc., onto the display unit 20, the detailed information acquiring unit 12 acquires only the corresponding contents after the arrangement of the contents displayed onto the display unit 20 is determined.

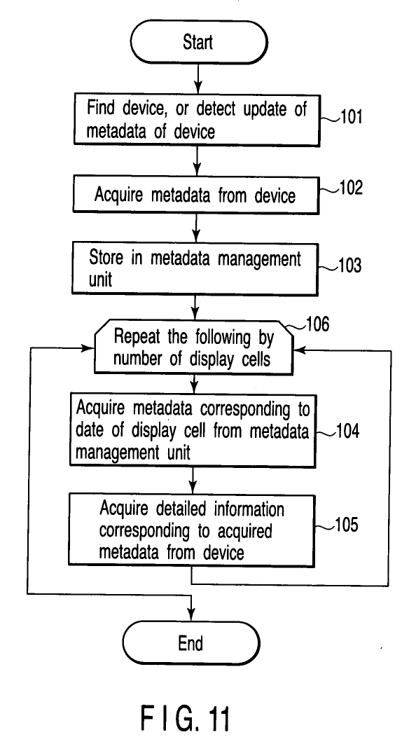

Thereby, while suppressing the memory consumption amount of the display device 10, the retrieval result can be displayed at a high rate. FIG. 11 is a flowchart illustrating the foregoing operations of the display device 10 as a whole.

In FIG. 11, at first when the device finding unit 13 finds the devices or detects the update of the metadata of the devices (block 101), the metadata acquiring unit 15 acquires the metadata from the concerned devices (block 102). The device management unit 16 stores the acquired metadata in the metadata management unit 17 (block 103). Thus, the all items of the latest metadata of the devices with power applied thereto are stored in the metadata management unit 17.

The item management unit 19 acquires the metadata corresponding to the dates of the display cells at which the displays are instructed, from the metadata management unit 17 (block 104). The detailed information acquiring unit 12 acquires the detailed information corresponding to the acquired metadata from the corresponding devices (block 105). The item management unit 19 repeats the processes in blocks 104-105 by the number of display cells (block 106).

As described above, the metadata acquiring unit 15 collects the metadata necessary for retrieving and sorting of the contents in advance, and the metadata management unit 17 manages (stores) the collected metadata. When the display of the metadata is actually required (display is instructed), the detailed information acquiring unit 12 acquires the detailed information not included in the metadata management unit 17 from the corresponding each device. Therefore, according to the embodiment, while suppressing the memory volume needed to manage the metadata at minimum, the display device 10 becomes possible to perform the sorting and displaying in a list of the contents at a high rate.

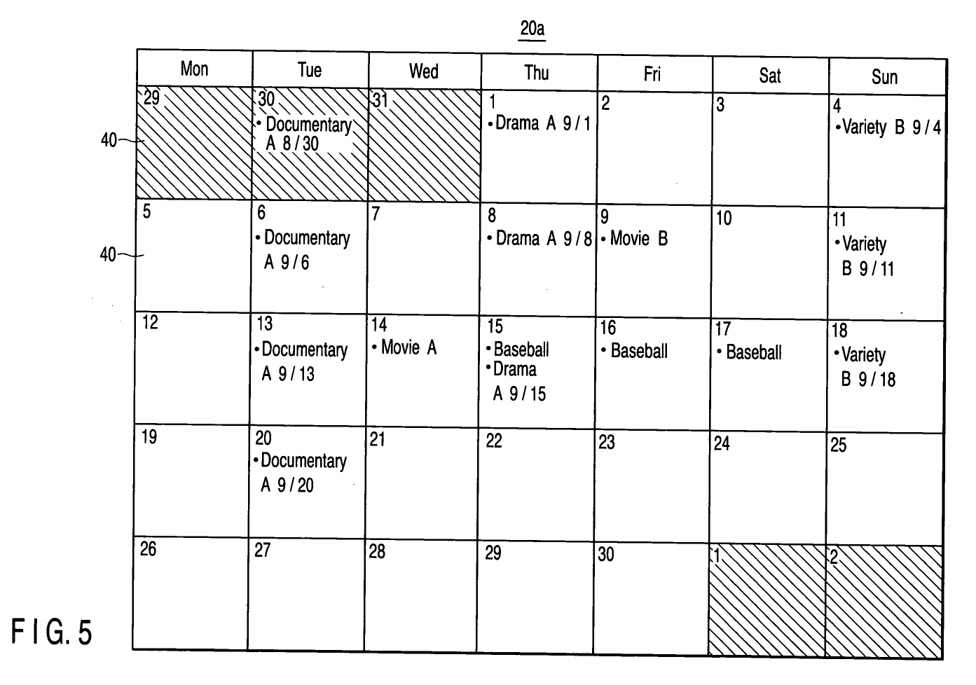

FIG. 5 is a view showing a first embodiment of the content list display screen by the network content display device 10 of the invention, as a content list display screen 20a.

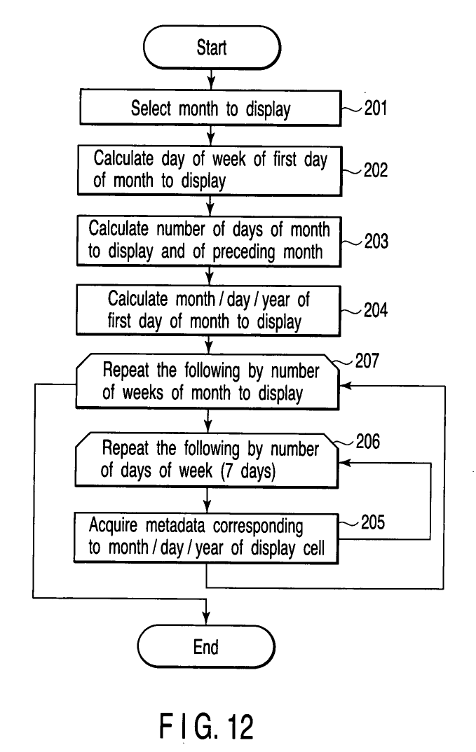

FIG. 5 depicts an example to arrange and display the metadata of the contents on a calendar. The display item management unit 19 displays each area on the calendar as date cell for display 40, acquires the metadata of the contents corresponding to each date cell 40 from the metadata managing unit 17 from the meta data reading unit 18, and arranges the metadata in each data cell. FIG. 12 is a flowchart to create the display screen.

In FIG. 12, the display item managing unit 19 selects the month to display in response to the user's instruction (block 201), calculates the day of the week for the first day of the month to display (block 202), calculates the number of days of the month to display and of its preceding month (block 203), and calculates the month, day and year of the first of the month to display (block 204).

Next to this, the display item management unit 19 acquires the metadata corresponding to the month, day and year of the display cell (block 205), and repeats the acquiring process of the number of days (seven days) in the week (block 206). Further, the item management unit 19 repeats the processes in blocks 205 and 206 by the number of weeks of the month to display (block 207).

Like this manner, according to the first embodiment of the content list display screen, displaying only the metadata of the contents onto the calendar screen makes a display at a further high rate possible. This scheme is effective when the calendar screens are continuously switched (with scroll) to search the recorded content. The display device 10 may display the device names with each content displayed in the date cells stored therein in the concerned date cells. In such a case, it is easily determined what content is stored in which device.

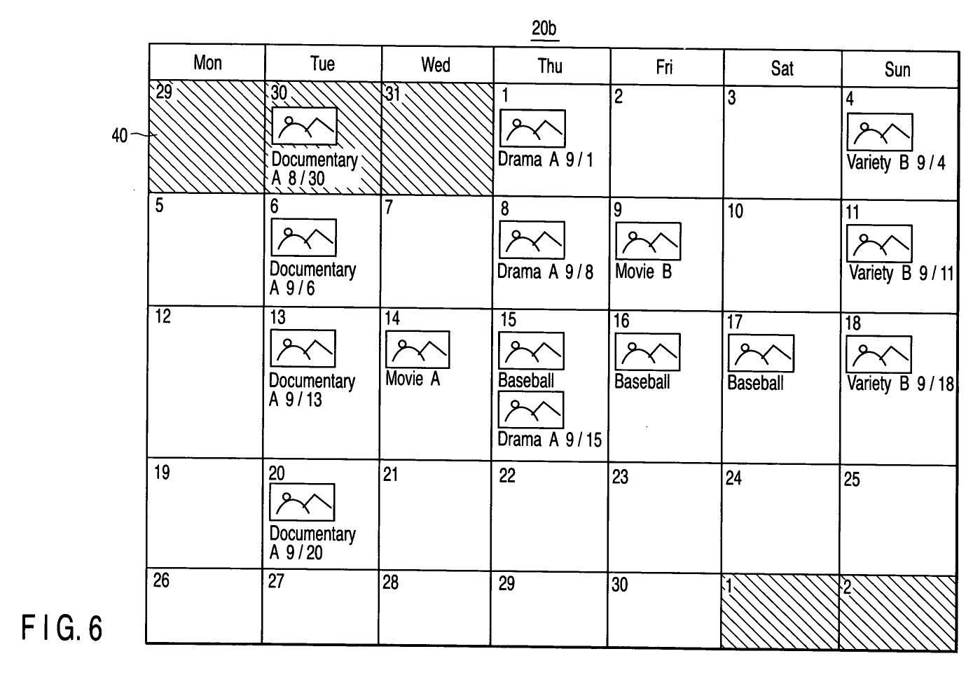

FIG. 6 is a view illustrating a second embodiment of the content list display screen by the display device 10 of the invention, as a content list display screen 20b.

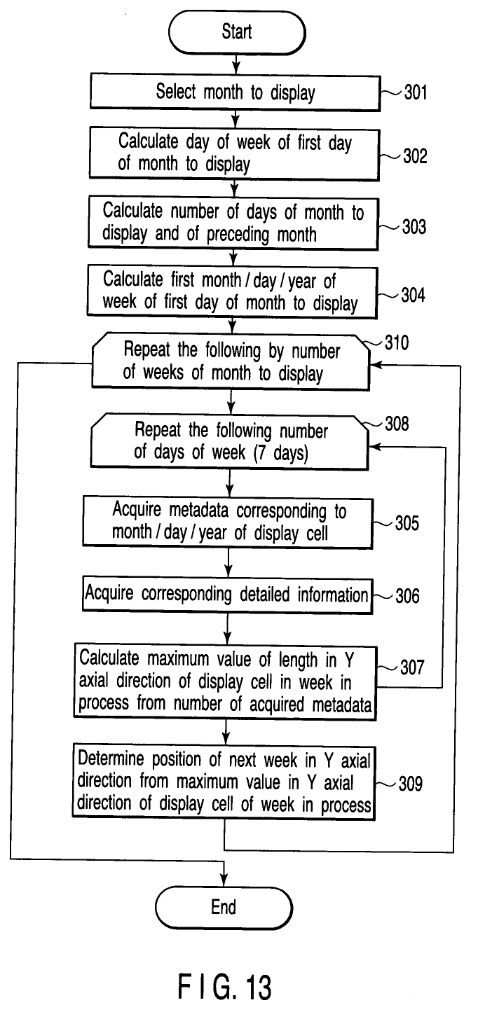

FIG. 6 depicts an example to display thumbnails of the contents in addition to the metadata display in FIG. 5. As shown in FIG. 5, after the item management unit 19 acquires the metadata of the contents corresponding to each date cell, this display may be realized in a manner by which the detailed information acquiring unit 12 acquires the thumbnail information accompanying only those contents from each corresponding device. FIG. 13 is a flowchart to create such a display screen.

In FIG. 13, the item management unit 19 selects the month to display (block 301), calculates the day of the week of the first day of the month to display (block 302), calculates the number of days of the month to display and of its preceding month (block 303), and calculates the month, day and year of the first day of the month to display (block 304).

Next, the item management unit 19 acquires the metadata corresponding to the month, day and year of the display cell from the corresponding device (block 305), and acquires the corresponding detailed information (thumbnail) from the concerned devices (block 306). The item managing unit 19 calculates a maximum value of a length in a Y axial direction (longitudinal direction) of the display cells in the week in processing from the number of pieces of the acquired meta data (block 307). The item managing unit 19 repeats the processes in blocks 305-307 of the number of days in the week (seven days) (block 308), and determines the positions of the next week in the Y axial direction from the maximum value in the Y axial direction of the display cells in the week in processing (block 309). Further, the item management unit 19 repeats the processes in blocks 305-309 by the number of weeks of the month to display (block 310).

Like this, according to the second embodiment of the content list display screen, by displaying the detailed information (thumbnail) other than the metadata, each content can be known in detail. In the embodiment shown in FIG. 6, if the number of pieces of the metadata and the detailed information included in each display cell 41, sizes of the display cells are enlarged in response to the user's instruction (including selection of content) and many pieces of the metadata and the detailed information are displayed clearly.

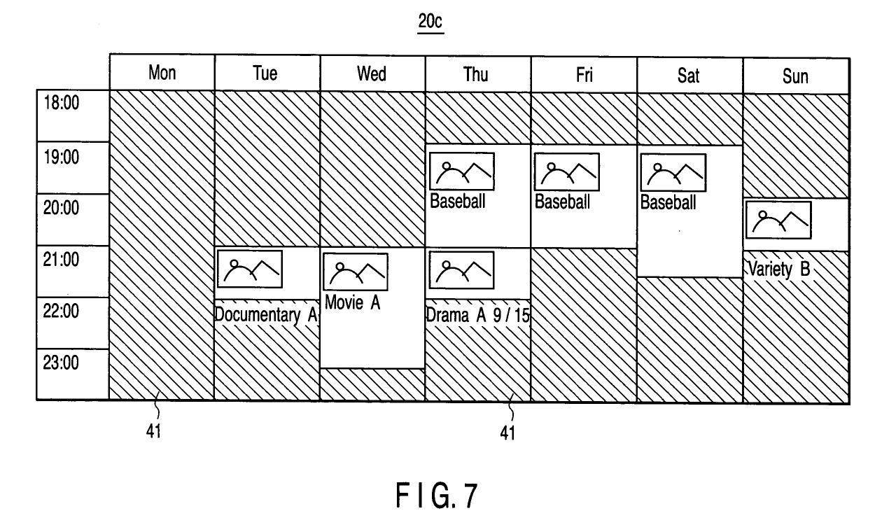

FIG. 7 is a view illustrating a third embodiment of the content list display by the display device 10 in the invention, as a content list display screen 20c.

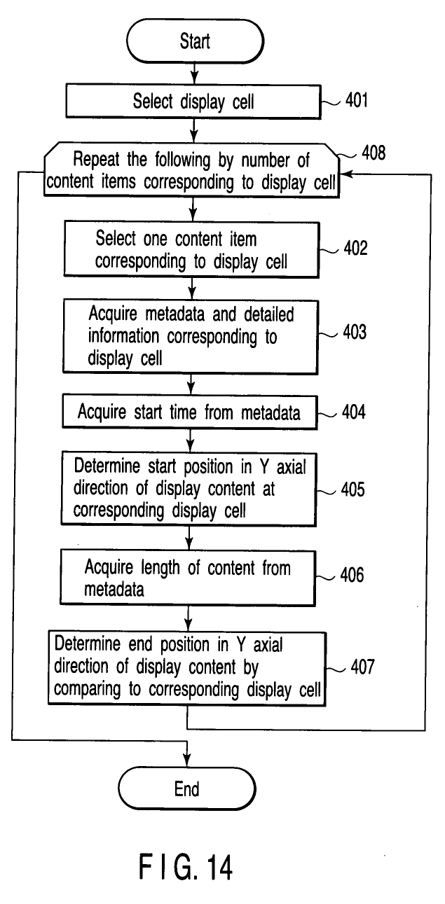

Here, display cells 41 to be treated by the item management unit 19 are constituted in predetermined time lengths. A display area of each day, for example, of 18:00 to 24:00 is equivalent to one display cell 41, and for instance, two contents of “base ball” and “drama, September fifteenth” are displayed in the display cell 41 of Thursday. FIG. 14 is a flowchart to prepare this display screen.

In FIG. 14, the display item management unit 19 selects a display cell (block 401), selects one content corresponding to the display cell (block 402), and acquires the metadata and the detailed information corresponding to the display cell (block 403). The item management unit 19 obtains the start time form the metadata (block 404), and determines the star position in the Y axial direction of the display content (metadata and detailed information) in the corresponding display cell 41. The management unit 19 obtains the length (reproduction time) of the content from the metadata (block 406), and compares the length with the length of the corresponding display cell 41 to determine the end position in the Y axial direction of the display content (block 407). The management unit 19 repeats the processes in blocks 402-407 of the number of contents corresponding to the display cell (block 408).

Further, the management unit 19 determines the arrangement positions on the display cells 41 of each display content in response to the recording times of “base ball” and “drama, September fifteenth”. In the example of FIG. 7, “base ball” is arranged at the position of 19:00-21:00, and “drama, September fifteenth” is arranged at the position of 21:00-22:00.

Like this, according to the third embodiment of the content list display screen, the time bands in which the contents are recorded (broadcast) can be determined visually.

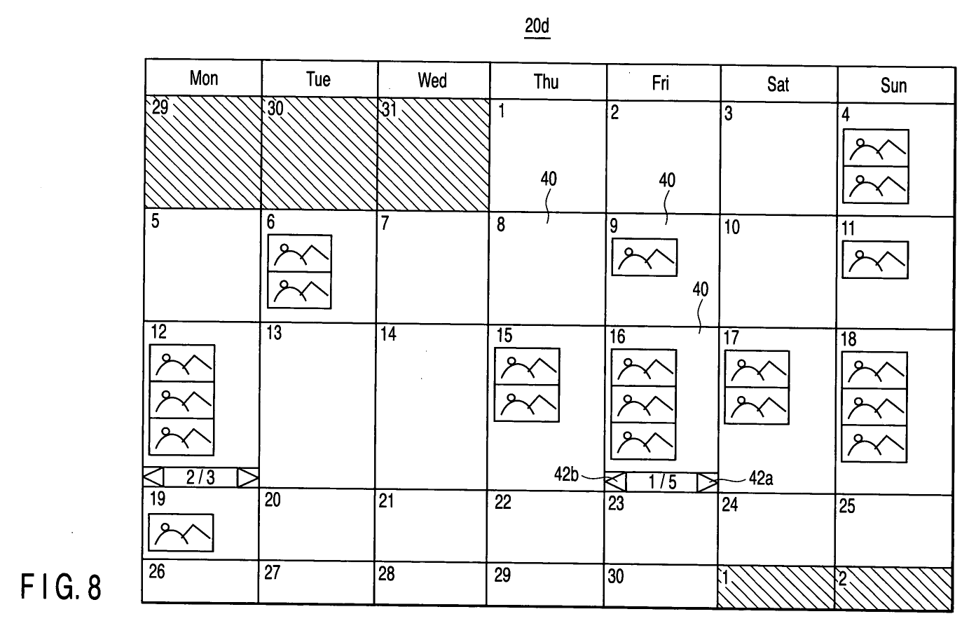

FIG. 8 is a view illustrating a fourth display screen of the content list display of the display device 10, as a content list display screen 20d.

Here, a display screen is indicated for the time when the display device 10 selects only thumbnails of the contents as the items to display. The basic process is similar to that of the display in FIG. 6; however the display item managing unit 19 automatically changes the size of the date cell in weeks in response to the number of contents displayed in the date cell. Further, the management unit 19 divides a plurality of contents into a plurality of pages to arrange buttons 42 to turn the pages if the number of contents belonging to the date cell and a plurality of contents do not fit into one cell.

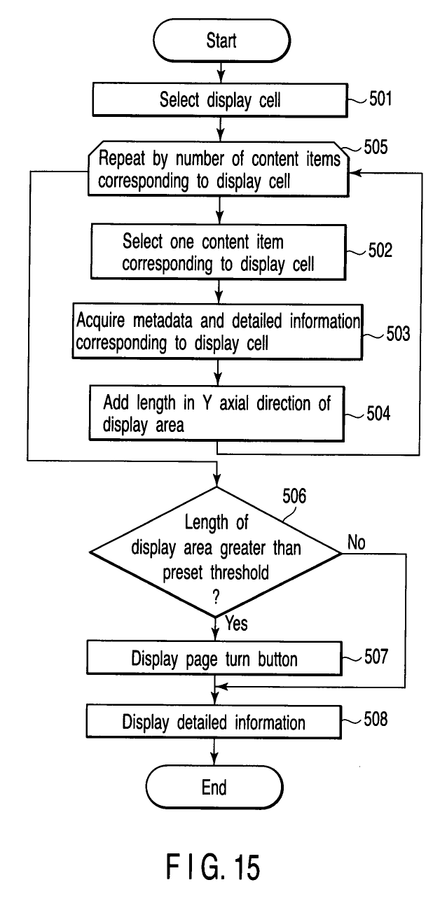

For instance, the 16th data cell 40 consists of five pages, and the first page among them is displayed. The user selecting a button 42a invokes display of the next page, and selecting a button 42b invokes the preceding page. FIG. 15 is a flowchart to prepare the display screen.

In FIG. 15, the item management unit 19 selects a display cell (block 501), selects one content corresponding to the selected display cell (block 502), acquires the metadata and the detailed information corresponding to the display cell (block 503), and adds a length in a Y axial direction of a display area (block 504). The item management unit 19 repeats the processes in blocks 502-504 of the number of contents corresponding to the display cell (block 505).

Further, the item management unit 19 determines whether the length of the display area is longer than the preset threshold (block 506), if longer, it displays page turning buttons 42a and 42b (block 507) to display the detailed information (block 508). If the length of the display area is shorter than the preset threshold in block 506 (if “No”), the flow shifts to block 508 to display the detailed information (block 508).

The fourth embodiment of the content list display screen makes it possible to display the content, even if the number of contents belonging to the one date cell is large.

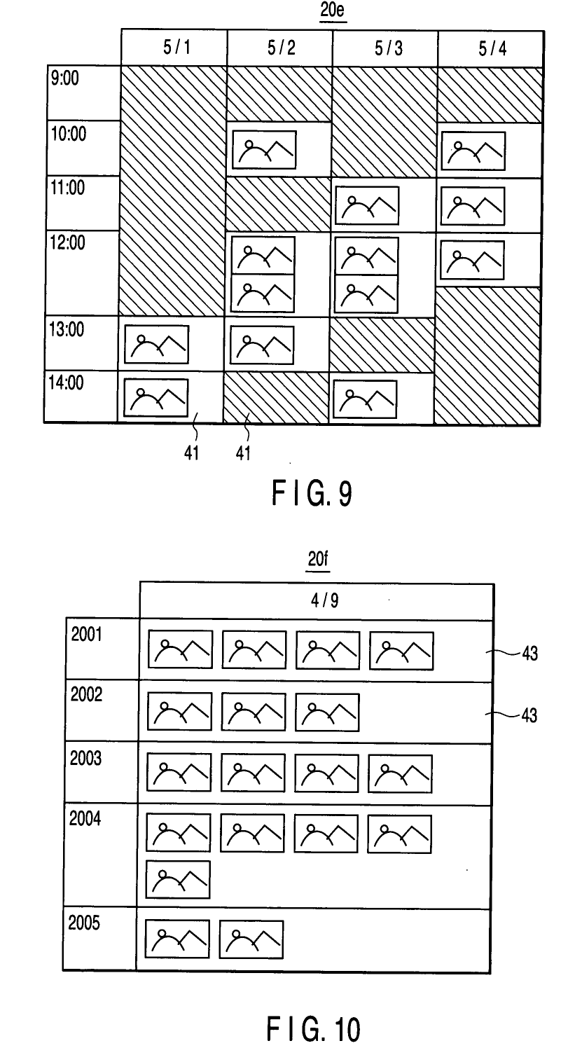

FIG. 9 is a view illustrating a fifth embodiment of the content list display by the network content display device 10, as a content list display screen 20e.

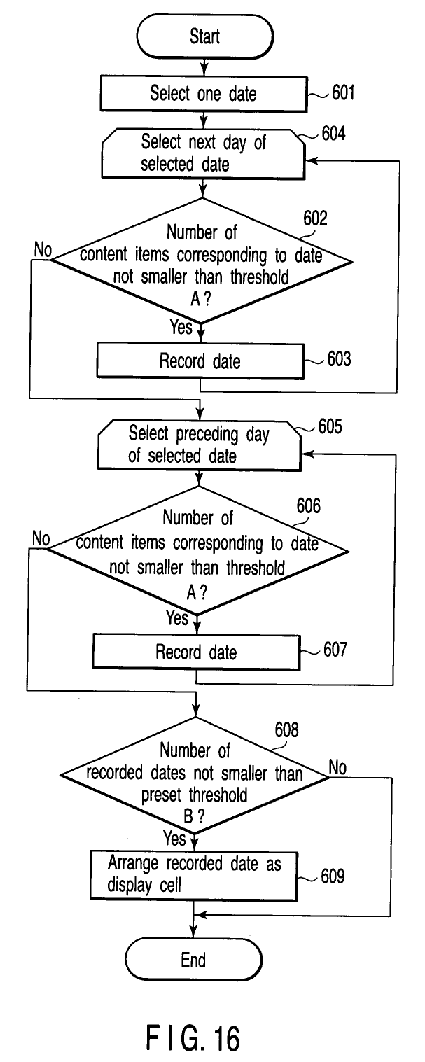

In display of the content lists in month like FIG. 5 or FIG. 6, when the user selects one date cell, the management unit 19 compares the number of contents in the date cell to a predetermined threshold A (including 1). If the display cell including the contents not smaller than predetermined threshold A lasts for predetermined threshold B (number of days) or more including the concerned display cell, the item management unit 19 switches the display screen to the screen shown in FIG. 9, to display the series of the display cells in times. FIG. 16 is a flowchart to create such a display screen.

The item management unit 19 selects one date in response to the user's instruction (block 601), and determines whether or not the number of contents corresponding to the date are present not less than threshold A (block 602). If the number is equal to threshold A or larger, the item management unit 19 records the date (block 603), selects the date next to the selected date (block 604) then executes the process of block 602. The item management unit 19 repeats the processes of blocks 602-604 until it is determined as “No” in block 602.

If the number of contents corresponding to the selected date is smaller than threshold A (No, in block 602), the item management unit 19 selects the date of the preceding day of the date firstly selected in block 601 (block 605) to determine whether the number of contents corresponding to the date is equal to or over threshold A (block 606). If the number is equal to or over threshold A, the item management unit 19 records the date (block 607). Then, the item management unit 19 selects the date of the preceding day of the data currently selected (block 605) to execute the process of block 606. Until it is determined as “No” in block 606, the item management unit 19 repeats the processes of blocks 605-607.

If the number of contents corresponding to the selected date is smaller than threshold A (No, in block 606), the item management unit 19 determines whether the number of dates recorded in blocks 603 and 607 are predetermined threshold B or larger (block 608). If the number of dates is equal to or larger than threshold B, the item management unit 19 arranges the cells corresponding to the recorded dates as display cells. If the recorded number is not larger than predetermined threshold B (No, in block 608), the flow comes to end.

The display method regarding the fifth embodiment is applicable, for example, to list-display still images or motion images photographed by a digital camera on an overnight trip. The item management unit 19 automatically selecting and displaying the display cells of consecutive dates, a simple user operation allows a list display of the photographs of the trip. It may be added for a condition to switch over to the display in FIG. 9 that the device on the network 31 is a camera in addition to the number of contents not smaller than threshold A and the number of consecutive days not smaller than threshold B.

FIG. 10 is a view illustrating a sixth embodiment of the content list display by the display device 10, as a content list display screen 20f.

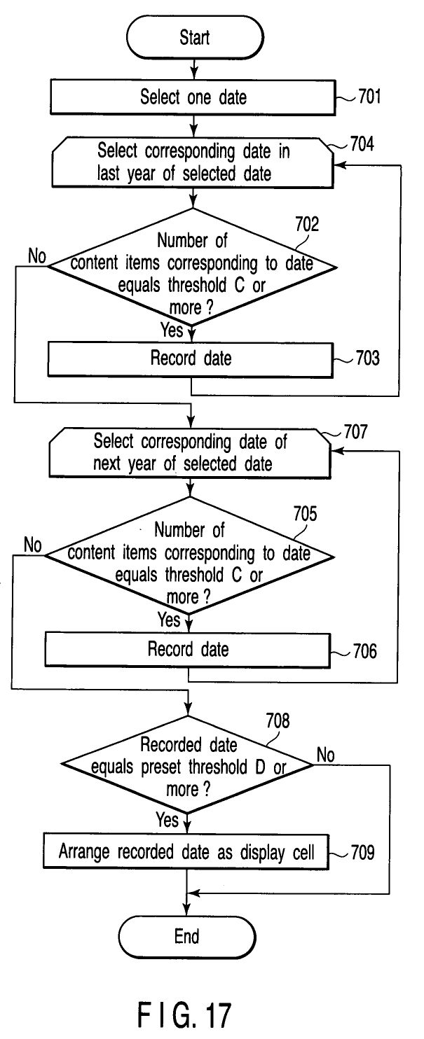

If the user selects one date cell, when the item management unit 19 displaying the content list in months as shown in FIG. 5, or FIG. 6, it compares the number of contents (still image and motion image) photographed, for instance, by a digital camera in the selected data cell to a predetermined threshold C (including 1). If the selected data cell includes the number of contents of predetermined threshold C or more, the display item management unit 19 determines whether the content, acquired by the digital camera on the same day in the sequencing years not less than threshold D years including the year, are present or not. If the contents not smaller than threshold C are present in every year, the item management unit 19 switches from the display in FIG. 5 or FIG. 6 to one in FIG. 10 to display a list of the date cells 43 of each year. FIG. 17 is a flowchart to create such a display screen.

In FIG. 17, the item management unit 19 selects one date in response to the user's instruction (block 701) to determine whether the number of contents corresponding to the selected date is equal to or larger than threshold C (block 702). In the case of being not smaller than threshold C, the item management unit 19 records the date (block 703). The item management unit 19 then selects the corresponding date in the last year from the selected date (block 704) to execute the process in block 702. Until it is determined as “No” in block 702, the item management unit 19 repeats the processes of block 702-704.

If the contents corresponding to the selected date is not present in the number of threshold C or more (No, in block 702), the item management unit 19 selects the corresponding date in the years later than the selected date (block 704), and determines whether the number of contents equal to or more than threshold C are present or not (block 705). If the number is not smaller than threshold C, the item management unit 19 records the date (block 706). The item management unit 19 then selects the corresponding dates later than the years of the selected date in turn to repeat the processes in blocks 705 and 706 (block 605).

If the number of contents corresponding to the selected date is not more than threshold C (No, in block 705), it is determined whether the recorded date is not smaller than predetermined threshold D (block 707), if it is not smaller than threshold D, the recorded date is disposed as the display cell (block 708). If the recorded date is smaller than threshold D (No, in block 707), the flow ends.

For instance, displaying the process of an event, such as a birthday and a wedding anniversary, celebrated yearly is an example to which the display method in the sixth embodiment is applied. The display item management unit 19 automatically selecting the annual events, the user can display a list of such events with a simple operation and reproduce to display the contents such as a growth record of a child with ease.

The descriptions given above express the embodiments of the invention, the device and method of invention are not limited to the embodiments, and this invention may be embodied in various forms easily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A network content display device, comprising:
a communication unit which communicates with a plurality of communication devices, each having image content, via a network:
an information acquiring unit which acquires information, relating to image contents possessed by the plurality of communication devices connected to the network, via the communication unit, as content information; and
a display management unit 19 which displays a calendar screen including a plurality of display areas composed in days onto a display unit, and displays each content information acquired by the information acquiring unit onto the calendar screen on the basis of recording dates and times of the image contents.

2. The device according to claim 1, wherein
the display management unit determines each size of each display area in response to the number of pieces of the content information included in each of the display areas on the calendar screen.

3. The device according to claim 1, wherein
the display management unit arranges to display the content information in each display area on the calendar screen in response to recording times of each image content.

4. The display according to claim 1, further comprising a detection unit which detects the fact that the image contents are recorded at consecutive dates and not less than a predetermined number of image contents is recorded at each date of the consecutive dates, wherein
the display managing unit arranges to display the content information in each display area on the calendar screen including the display areas of the consecutive dates, in response to recording times of each image content.

5. The device according to claim 1, further comprising a detection unit which detects display areas each including not less than a predetermined number of contents and having the same date of consecutive years, wherein
the display management unit displays display areas detected from the detection unit and having the same date, by year.

6. A network content display method, comprising:
acquiring information, relating to image contents possessed by a plurality of communication devices connected to a network, via the network, as content information; and
displaying a calendar screen including a plurality of display areas composed in days onto a display unit, and displaying the acquired each content information onto the calendar screen on the basis of recording dates and times of the image contents.

7. The method according to claim 6, wherein the displaying the content information includes determining each size of each display area in response to the number of pieces of the content information included in each of the display areas on the calendar screen.

8. The method according to claim 6, wherein the displaying the content information includes arranging to display the content information in each display area on the calendar screen in response to recording times of each image content.

9. The method according to claim 6, further comprising detecting the fact that the image contents are recorded at consecutive dates and not less than a predetermined number of image contents is recorded at each date of the consecutive dates, wherein
the displaying the content information includes arranging to display each content information in each display area on the calendar screen including the display areas of the consecutive dates, in response to recording times of each image content.

10. The method according to claim 6, further comprising detecting display areas each including not less than a predetermined number of contents and having the same date of consecutive years, wherein
the displaying the content information includes displaying the detected display areas by year.
